(19) United States
(12) Patent Application Publication
(10) Pub. No.: US 2002/0116393 A1
(43) Pub. Date: Aug. 22, 2002

(54) Method for automatic electronic transmission of lost person information

(76) Inventors: Matthew Aaron Goldstein, Cave Creek, AZ (US); William Henry Conley III, Marana, AZ (US)

Correspondence Address: Matthew A. Goldstein, c/o William H. Conley, 33631 East Future Road, Marana, AZ, 85653, US

(21) Appl. No.: 10/011,922

(22) Filed: Oct. 30, 2001

Related U.S. Application Data
(60) Provisional application No. 60/269,504, filed on Feb. 16, 2001.

(51) Int. Cl. G06F 7/00

(52) U.S. Cl. 707/104.1

(57) ABSTRACT

A method for automatically transmitting information on a lost person comprising the steps of storing user messages containing personal, travel, and outdoor recreation activity information on a database system and transmitting the user messages to predetermined message destinations upon the failure of the user to check in at a predetermined time the user registered with the system.

### BACKGROUND OF THE INVENTION

1. Field of the Invention

The invention relates generally to a method of transmitting information on a lost person. More specifically, the invention relates to the automatic transmission of personal, travel, and outdoor recreation activity information over the World Wide Web (WWW) or a local area network (LAN).

2. Description of Related Art

Every year, thousands of individuals become lost in the course of travel and outdoor recreation activities. On land and at sea, there are thousands of search and rescue incidents resulting in thousands of lives saved and unfortunately, many lives lost. Of those lives lost, many die because notification of their lost status was made too late. Hence, there is a great need for systems assisting in the notification and location of individuals at risk of becoming lost while traveling or engaged in outdoor recreation activities.

The present invention is a method designed for use by persons engaged in activities where they may become lost. These activities include but are not limited to travel and outdoor recreation activities. References to outdoor recreation activities may include but are not limited to: hiking, backpacking, wilderness expeditions generally, rock climbing, skiing, hunting, boating, scuba diving, and recreational flying.

Related methods presently employed to safeguard persons at risk of becoming lost while engaged in travel and outdoor recreation activities include: maps and mapping devices; compass and global positioning system devices; trailhead post sign-in rosters; notification of friends and family of outdoor recreation plans and travel arrangements; notification of public safety agencies of outdoor recreation plans and travel arrangements; posting of outdoor recreation plans and travel arrangements on electronic bulletin boards, and; personal information posted on databases accessible upon notification of an emergency situation at which time the information can be retrieved and disseminated. The problem with these methods is that they (1) require detection of the lost person's status by an external source; (2) require notice from the external source to prompt the retrieval and transmission of information on the lost person; and, (3) they do not provide sufficiently detailed information concerning the lost person's travel and outdoor recreation activity plans.

The term “lost person” defines a status wherein no source external to the person is aware of the person's location. Thus, by definition, the requirement that a source external to the lost person detect the lost person's status and location does little in the way of solving the problem. Moreover, it is the fact that a source external to the lost person does not detect the lost person's status as lost that is the problem. Further, when noticed, prompting from an external source to a centralized database to transmit information on the missing person is a duplication of tasks that consumes valuable time that may be of critical importance. Additionally, the subsequent transmission of information that a person is “lost” without the detailed information necessary to assist rescuers in ascertaining the lost person's location merely notifies of a status and does little in the way of solving the problems inherent in that status (i.e., the person will remain a lost person until information is provided that assists in their location so that they may become found). What is needed is a method that does not require detection and notification of the lost person's status by an external source and that provides detailed information concerning the lost person's travel and outdoor recreation activity plans.

The present invention is distinct from the related art. It creates an automated method of emergency notification wherein messages are transmitted to message destinations based solely on a user's failure to check in with the system. After a user pre-registers their personal identifying and activity information with the system database on the World Wide Web (WWW) or a local area network (LAN) and fails to check in with the system by the requisite time, no further outside notifications are required for the system to be activated whereupon the user's information is automatically retrieved and disseminated to message destinations. Thus, no event is required for a message to be transmitted since the system does not require user action other than pre-registering and compiling the message for transmission.

Advantageously, the present invention is a first in line notification method and resolves problems inherent in related emergency notification methods that are secondary and dependent on notification of a lost person's status from some external source before they can transmit information on the lost person. Additionally, the present invention can store and disseminate detailed information concerning the lost person's travel and outdoor recreation activity plans necessary to assist rescuers in ascertaining a lost person's location.

Other related methods further require the use of identification cards, tags or other devices that can be discovered on a person suspected of being lost wherein a reporting party may use a toll free or other telephone number to contact a central database via voice communications and notify the database of the lost person's status or location. Again, the present invention does not require this external notification that a person has become lost to activate the system and does not require the use of identification cards, tags, or other devices worn by the lost person.

### BRIEF SUMMARY OF THE INVENTION

The invention is a method for automatically transmitting information on a lost person comprising the steps of storing user messages containing personal, travel, and outdoor recreation activity information on a database system and transmitting the user messages to predetermined message destinations upon the failure of the user to check in at a predetermined time the user registered with the system.

Users of the system include, but are not limited to, travelers and outdoor recreation users. Users register their personal identifying information, their travel, and outdoor recreation activity plans, the time they plan to return and an emergency message with the system database which is maintained at and accessible from a World Wide Web (WWW) or local area network site. The user further selects message destinations of the persons, agencies or entities to be notified in the event the user fails to check in with the system by their scheduled return time. If the user fails to check in with the system by the pre-designated return time, the system automatically sends the user's emergency message and personal identifying information to the message destinations the user selected.

### BRIEF DESCRIPTION OF THE DRAWINGS

FIG. 1 is flowchart illustrating the steps involved in one embodiment of the present invention; and

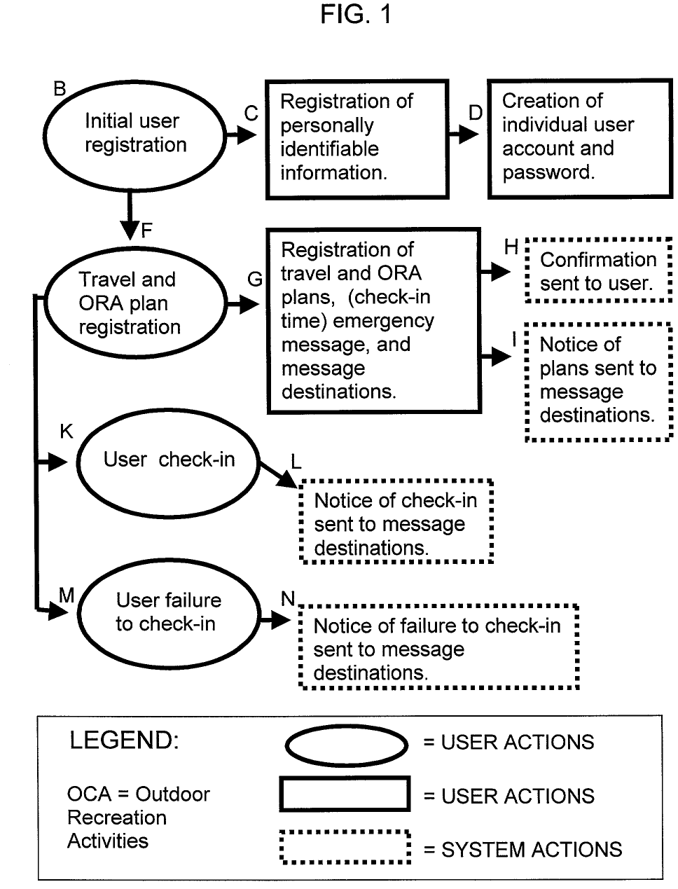

FIG. 2 is a flowchart illustrating the steps involved in subscription to one embodiment of the present invention.

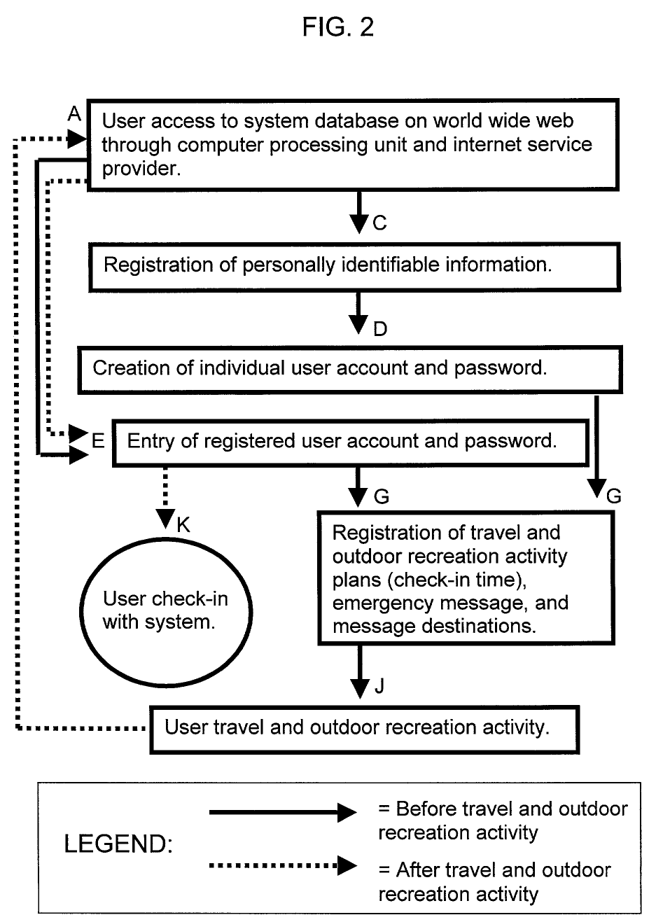

### DETAILED DESCRIPTION OF THE INVENTION

The invention relates generally to a method of transmitting information on a lost person. More specifically, the invention relates to the automatic transmission of personal, travel, and outdoor recreation activity information over the World Wide Web (WWW) or a local area network (LAN). It is designed for use by persons engaged in activities where they may become lost. Such activities include but are not limited to travel and outdoor recreation activities. References to outdoor recreation activities may include but are not limited to: hiking, backpacking, wilderness expeditions generally, rock climbing, skiing, hunting, boating, scuba diving, and recreational flying.

The invention is designed to supplement other emergency notification systems currently in place and to assist search and rescue measures by alerting family, friends, public safety officials, and other entities of a user's failure to return from travel, outdoor recreation activity or other activity and by providing the detailed information necessary to assist rescuers in finding the user's location. It requires the user to enter messages containing user personal, travel, and outdoor recreation activity information on a database system. The method then transmits the user's messages to predetermined message destinations upon the failure of the user to check in at a predetermined time the user registered with the system.

In accord with one aspect of the invention, the method receives, stores, and electronically transmits said information from a web server on the World Wide Web (WWW). This enables a larger user group access and use of the method. As another respect, the method receives, stores, and electronically transmits said information from a server on a local area network (LAN). While permitting access to a smaller user group than the World Wide Web, this enables individual entity monitoring and special purpose utilization of invention. Use of the terms World Wide Web and local area network correspond to the method's use of a database system linked to an Internet or Intranet site respectively.

In accord with several aspects of the invention and in a preferred embodiment, users initially access the system database on the World Wide Web through a computer processing unit and internet service provider (A) and register with the system prior to travel or outdoor recreation activity plans (B). During this initial step, users register personally identifiable information including hair color, eye color, height, and weight (C). Preferably, users may also attach files in .jpg, .gif, .tif, or other graphic formats to the emergency message. Further preferable, each user will create an individual account by entering a username and password (D).

When the user plans travel and outdoor recreation activity, they access the system database (A) and enter their username and password (E). They then register their specific travel or outdoor activity plan information with the system (F). Preferably, this information includes an emergency message to be sent, the date the user plans to leave, the date and time they are scheduled to return home, and electronic mail addresses for the user's emergency message to be sent to in the event they fail to check in with system by the scheduled time of return (G). Further preferable, users may include alphanumeric pager or personal data assistant addresses as other message destinations for the emergency message to be sent.

After completion of the specific travel, outside activity or other activity information entry, the system will confirm the user's data before acceptance via a confirmation message that is sent to the user's electronic mail address (H). As another respect, the system will also send a notice to the message destinations registered by the user, notifying the message recipients of the user's plans (I). The user then engages in the travel and outdoor recreation activity (J).

When the user returns from the activity, they access (A) and check in with the system (K) and the system automatically sends a message that the user has returned to the message destinations the user registered with the system (L). If the user does not check in with the system before the scheduled return home time (M), the emergency message the user composed is automatically sent to the message destinations the user registered with the system (N).

Advantageously, the system is a first in line notification system and resolves problems inherent in other emergency notification systems that are secondary and dependent on notification of a lost or missing person's status from some outside or foreign source before they can disseminate the lost or missing person's personally identifiable information. Additionally, many of these prior systems do not store and disseminate detailed descriptions of the lost or missing persons travel, outdoor recreation activity or other activity plans. The present system stores and disseminates this information.

The invention has been described in detail with particular reference to a preferred embodiment thereof, but it will be understood that the invention is capable of other and different embodiments. As is readily apparent to those skilled in the art, variations and modifications can be affected in the spirit and scope of the invention. Accordingly, the foregoing written description and specification is for illustrative purposes only, and does not in any way limit the invention, which is defined only by the claims.

What is claimed is:

1) A method for automatically transmitting information on a lost person comprising the steps of: storing user messages containing personal, travel, and outdoor recreation activity information on a database system; and transmitting the user messages to predetermined message destinations upon the failure of the user to check in at a predetermined time the user registered with the system.

2) A method for automatically transmitting information on a lost person recited in claim 1, wherein said method receives, stores, and electronically transmits said information from a web server on the World Wide Web (WWW).

3) A method for automatically transmitting information on a lost person recited in claim 1, wherein said method receives, stores, and electronically transmits said information from a server on a local area network (LAN).

4) A method for automatically transmitting information on a lost person recited in claim 1, further comprising the step of user entry of message locations that are predetermined by the user and where said message locations consist of electronic mail, alphanumeric pager, and personal data assistant addresses (PDA).

5) A method for automatically transmitting information on a lost person recited in claim 1, further comprising the step of user entry of message locations that are predetermined by the user and where said message locations consist of electronic mail, alphanumeric pager, and personal data assistant addresses (PDA); and wherein said method receives, stores, and electronically transmits said information from a web server on the World Wide Web (WWW).

6) A method for automatically transmitting information on a lost person recited in claim 1, further comprising the step of user entry of message locations that are predetermined by the user and where said message locations consist of electronic mail, alphanumeric pager, and personal data assistant addresses (PDA); and wherein said method receives, stores, and electronically transmits said information from a server on a local area network (LAN).

7) A method for automatically transmitting information on a lost person recited in claim 1, further comprising the steps of receiving and storing to the database a specified message composed by the user to be sent to the message destinations the user registered with the system in the event the fails to check in with the system by a predetermined time

8) A method for automatically transmitting information on a lost person recited in claim 1, further comprising the steps of receiving and storing to the database a specified message composed by the user to be sent to the message destinations the user registered with the system in the event the user fails to check in with the system by a predetermined time; and wherein said method receives, stores, and electronically transmits said information from a web server on the World Wide Web (WWW).

9) A method for automatically transmitting information on a lost person recited in claim 1, further comprising the steps of receiving and storing to the database a specified message composed by the user to be sent to the message destinations the user registered with the system in the event the user fails to check in with the system by a predetermined time; and wherein said method receives, stores, and electronically transmits said information from a server on a local area network (LAN).

10) A method for automatically transmitting information on a lost person recited in claim 1, further comprising the step of confirming the user's data via a confirmation message which is sent to the user's personal electronic mail, alphanumeric pager or personal data assistant address after their entry of specific travel or outdoor recreation activity.

11) A method for automatically transmitting information on a lost person recited in claim 1, further comprising the step of confirming the user's data via a confirmation message which is sent to the user's personal electronic mail, alphanumeric pager or personal data assistant address after their entry of specific travel or outdoor recreation activity; and wherein said method receives, stores, and electronically transmits said information from a web server on the World Wide Web (WWW).

12) A method for automatically transmitting information on a lost person recited in claim 1, further comprising the step of confirming the user's data via a confirmation message which is sent to the user's personal electronic mail, alphanumeric pager or personal data assistant address after their entry of specific travel or outdoor recreation activity; and wherein said method receives, stores, and electronically transmits said information from a server on a local area network (LAN).

13) A method for automatically transmitting information on a lost person recited in claim 1, further comprising the step of electronically sending notice to the message destinations registered by the user, notifying the message recipients of the user's travel or outdoor recreation plans.

14) A method for automatically transmitting information on a lost person recited in claim 1, further comprising the step of electronically sending notice to the message destinations registered by the user, notifying the message recipients of the user's travel or outdoor recreation plans; and wherein said method receives, stores, and electronically transmits said information from a web server on the World Wide Web (WWW).

15) A method for automatically transmitting information on a lost person recited in claim 1, further comprising the step of electronically sending notice to the message destinations registered by the user, notifying the message recipients of the user's travel or outdoor recreation plans; and wherein said method receives, stores, and electronically transmits said information from a server on a local area network (LAN).

16) A method for automatically transmitting information on a lost person recited in claim 1, further comprising the steps of:
user entry of message destinations that are predetermined by the user and where said message destinations consist of electronic mail, alphanumeric pager, and personal data assistant addresses (PDA);
receiving and storing to the database a specified message composed by the user to be sent to the message destinations the user registered with the system in the event the user fails to check in with the system by a predetermined time;
confirming the user's data via a confirmation message which is sent to the user's personal electronic mail, alphanumeric pager or personal data assistant address after their entry of specific travel or outdoor recreation activity;
electronically sending notice to the message destinations registered by the user, notifying the message recipients of the user's travel or outdoor recreation plans; and
electronically sending the message that the user has returned to the message destinations registered by the user when the user returns from their travel, outdoor recreation activity or other activity and checks in with the service before the predetermined time.

17) A method for automatically transmitting information on a lost person recited in claim 1, further comprising the steps of:
user entry of message destinations that are predetermined by the user and where said message destinations consist of electronic mail, alphanumeric pager, and personal data assistant addresses (PDA);
receiving and storing to the database a specified message composed by the user to be sent to the message destinations the user registered with the system in the event the user fails to check in with the system by a predetermined time;
confirming the user's data via a confirmation message which is sent to the user's personal electronic mail, alphanumeric pager or personal data assistant address after their entry of specific travel or outdoor recreation activity;
electronically sending notice to the message destinations registered by the user, notifying the message recipients of the user's travel or outdoor recreation plans; and
electronically sending the message that the user has returned to the message destinations registered by the user when the user returns from their travel, outdoor recreation activity or other activity and checks in with the service before the predetermined time;
wherein said method receives, stores, and electronically transmits said information from a web server on the World Wide Web (WWW).

18) A method for automatically transmitting information on a lost person recited in claim 1, further comprising the steps of:
user entry of message destinations that are predetermined by the user and where said message destinations consist of electronic mail, alphanumeric pager, and personal data assistant addresses (PDA);
receiving and storing to the database a specified message composed by the user to be sent to the message destinations the user registered with the system in the event the user fails to check in with the system by a predetermined time;
confirming the user's data via a confirmation message which is sent to the user's personal electronic mail, alphanumeric pager or personal data assistant address after their entry of specific travel or outdoor recreation activity;
electronically sending notice to the message destinations registered by the user, notifying the message recipients of the user's travel or outdoor recreation plans; and
electronically sending the message that the user has returned to the message destinations registered by the user when the user returns from their travel, outdoor recreation activity or other activity and checks in with the service before the predetermined time;
wherein said method receives, stores, and electronically transmits said information from a server on a local area network (LAN).

19) A method of emergency notification comprising the steps of;
maintaining a database on the Internet or Intranet that is capable of storing personal information, travel plans, outdoor recreation activity, and other activity plans;
receiving and storing to the database personally identifiable information from users to include their height, weight, hair color, eye color, and clothing description;
receiving and storing to the database a username and individual password with the system;
receiving and storing to the database user travel, outdoor recreation activity, and other activity plans to include the date the user is scheduled to leave and the date and time they are scheduled to return home from the travel, outdoor recreation activity or other activity;
receiving and storing to the database email addresses, alphanumeric pager email addresses, and other message destinations registered by the user for emergency messages to be sent to in the event the user does not/fails to check in with system by the scheduled time of return;
receiving and storing to the database an emergency message composed by the user to be sent to the registered message destinations they registered with the system in the event they fail to check in with the system by their scheduled return time;
confirming the user's data before acceptance via a confirmation message which is sent to the user's email address or other message destination after their completion of the specific travel, outdoor recreation activity, or other activity data entry;
electronically sending notice to the email, alphanumeric pager email addresses, or other message destinations registered by the user, notifying the message recipients of the user's travel, outdoor recreation activity or other activity plans;
electronically sending the message that the user has returned to the email addresses, alphanumeric pager email addresses or other message destinations they registered with the system when the user returns from their travel, outdoor recreation activity or other activity and checks in with the service before/by the scheduled return home time;
electronically sending the emergency message the user composed to the email addresses and/or alphanumeric pager email addresses they registered with the system when the user does not check in with the service before/by the scheduled return home time.

20) A method of emergency notification consisting the steps of;
maintaining a database on the Internet or Intranet that is capable of storing personal information, travel plans, outdoor recreation activity, and other activity plans;
receiving and storing to the database personally identifiable information from users to include their height, weight, hair color, eye color, and clothing description;
receiving and storing to the database a username and individual password with the system;
receiving and storing to the database user travel, outdoor recreation activity, and other activity plans to include the date the user is scheduled to leave and the date and time they are scheduled to return home from the travel, outdoor recreation activity or other activity;
receiving and storing to the database email addresses, alphanumeric pager email addresses, and other message destinations registered by the user for emergency messages to be sent to in the event the user does not/fails to check in with system by the scheduled time of return;
receiving and storing to the database an emergency message composed by the user to be sent to the registered message destinations they registered with the system in the event they fail to check in with the system by their scheduled return time;
confirming the user's data before acceptance via a confirmation message which is sent to the user's email address or other message destination after their completion of the specific travel, outdoor recreation activity, or other activity data entry;
electronically sending notice to the email, alphanumeric pager email addresses, or other message destinations registered by the user, notifying the message recipients of the user's travel, outdoor recreation activity or other activity plans;
electronically sending the message that the user has returned to the email addresses, alphanumeric pager email addresses or other message destinations they registered with the system when the user returns from their travel, outdoor recreation activity or other activity and checks in with the service before/by the scheduled return home time;
electronically sending the emergency message the user composed to the email addresses and/or alphanumeric pager email addresses they registered with the system when the user does not check in with the service before/by the scheduled return home time.
